(19) United States
(12) Patent Application Publication
(10) Pub. No.: US 2025/0078643 A1
(43) Pub. Date: Mar. 6, 2025

(54) Shopping List Reminder Mobile Application

(71) Applicant: Reynaldo Pizarro, Holbrook, NY (US)

(72) Inventor: Reynaldo Pizarro, Holbrook, NY (US)

(21) Appl. No.: 18/822,546

(22) Filed: Sep. 3, 2024

Related U.S. Application Data
(60) Provisional application No. 63/580,056, filed on Sep. 1, 2023.

(51) Int. Cl. G08B 21/24; G06Q 30/0601; H04W 4/029

(52) U.S. Cl. CPC G08B 21/24; G06Q 30/0639; H04W 4/029

(57) ABSTRACT

A shopping list reminder mobile application is provided. The application allows a user to create a shopping list that may be manually or automatically sorted into a plurality of categories and subcategories relating to specific stores, item types, etc. The application then tracks the location of the user. When a user arrives at a store that a list has been created for, the application alerts the user via a notification and presents the list to the user.

### CROSS-REFERENCE TO RELATED APPLICATION

The present application claims priority to, and the benefit of, U.S. Provisional Application No. 63/580,056, which was filed on Sep. 1, 2023, and is incorporated herein by reference in its entirety.

### FIELD OF THE INVENTION

The present invention relates generally to the field of mobile applications. More specifically, the present invention relates to a shopping list reminder mobile application that allows a user to create a shopping list for at least one store, wherein the application then reminds the user of the shopping list when they travel to said store. Accordingly, the present disclosure makes specific reference thereto. Nonetheless, it is to be appreciated that aspects of the present invention are also equally applicable to other like applications, devices, and methods of manufacture.

### BACKGROUND

Many individuals forget what specific items they need to purchase when they're at a store. This oversight can occur if they do not create a tangible, physical shopping list. The absence of such a list can lead to the need for repeated trips to the store to purchase forgotten items. This not only wastes time but also increases the possibility of impulse purchases.

While the idea of having a physical shopping list seems logical, the practicality of constantly carrying around a piece of paper can pose its own challenges. It can be cumbersome, easy to lose, and at times frustrating, especially when one has to search through a bag or pockets amidst a crowded store. As a result, many have transitioned to using their smartphones for this purpose. Creating a digital shopping list on one's phone seems like the ideal solution, providing accessibility and convenience. However, many individuals forget the existence of the shopping list they've created on their phones. This could result in the same issue as before: buying unnecessary items or forgetting the essential ones.

Therefore, there exists a long-felt need in the art for an improved shopping list. There also exists a long-felt need in the art for a shopping list reminder mobile application. More specifically, there exists a long-felt need in the art for a shopping list reminder mobile application that eliminates the need to carry a physical shopping list. Further, there exists a long-felt need in the art for a shopping list reminder mobile application that prevents a user from forgetting the existence of a digital shopping list when they arrive at a store.

The subject matter disclosed and claimed herein, in one embodiment thereof, comprises a shopping list reminder mobile application. The application allows a user to create a shopping list. The list may be then manually or automatically sorted into a plurality of categories and subcategories relating to specific stores, item types, etc. The application then tracks the location of the user. When a user arrives at a store that a list has been created for, the application alerts the user via a notification and presents the list to the user.

In this manner, the shopping list reminder mobile application of the present invention accomplishes all the foregoing objectives and provides an improved shopping list. More specifically, the application eliminates the need to carry a physical shopping list. Further, the application prevents a user from forgetting the existence of a digital shopping list when they arrive at a store.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a shopping list reminder mobile application that allows a user to create at least one shopping list, wherein the application then automatically notifies a user of the list when a user enters a store that has the items on said list. In this manner, the user will not forget to purchase said items when they enter said store. The mobile application can preferably be downloaded on any smart device such as, but not limited to, cell phone, computer, tablet, etc.

The first feature of the mobile application allows a user to create at least one list. A user can then type and/or select items into the list that they desire to purchase from said store. After creating at least one list, the mobile application may automatically or manually allow the user to sort the list into at least one category. In one embodiment, the category is the name and/or specific location of at least one store in which the items on the list are located. The application also allows a user to (or may automatically) sort the list into at least one subcategory. The subcategory may relate to the types of items on the list.

The mobile application also has at least one location feature which tracks the location of the smart device the application is installed on and also tracks the location of every type/brand of store that has been categorized. Then, the feature automatically detects when the smart device is present at one of said stores. Once the location feature detects that the smart device is present at a location of a store listed in the category, the application alerts a user via a notification feature. The notification feature then brings up any created lists for the category of the store and presents them to the user. This ensures the user is aware of the list(s) when they arrive at the store such that they can purchase each item on the list.

The present invention is also comprised of a method of using the device. First, a device is provided comprised of a mobile application that allows a user to create at least one shopping list that may be sorted into categories and/or subcategories, and then notify the user of the list when they are present at a store which contains the items on the list. First, a user downloads the application onto a smart device. Then, a user creates at least one shopping list. Then, the user may manually sort the list (or the application may automatically sort the list) into categories and subcategories. Next, a user can travel to a location of the store, wherein the mobile application reminds the user of the list when they arrive at the location and wherein a user can view the reminder on the smart device in the form of a notification.

Accordingly, the shopping list reminder mobile application of the present invention is particularly advantageous as it provides an improved shopping list. More specifically, the application eliminates the need to carry a physical shopping list. Further, the application prevents a user from forgetting the existence of a digital shopping list when they arrive at a store. In this manner, the shopping list reminder mobile application overcomes the limitations of existing methods and usages of shopping lists known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a graphical view of features of one potential embodiment of a shopping list reminder mobile application of the present invention in accordance with the disclosed architecture; and

FIG. 2 illustrates a flowchart of a method of using one potential embodiment of a shopping list reminder mobile application of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved shopping list. There also exists a long-felt need in the art for a shopping list reminder mobile application. More specifically, there exists a long-felt need in the art for a shopping list reminder mobile application that eliminates the need to carry a physical shopping list. Further, there exists a long-felt need in the art for a shopping list reminder mobile application that prevents a user from forgetting the existence of a digital shopping list when they arrive at a store.

The present invention, in one exemplary embodiment, is comprised of a shopping list reminder mobile application. The application allows a user to create at least one shopping list, wherein the application then automatically notifies a user of the list when a user enters a store that has the items on said list such that the user will not forget to purchase said items when they enter said store. The mobile application can preferably be downloaded on any smart device such as, but not limited to, cell phone, computer, tablet, etc.

The first feature of the mobile application allows a user to create at least one list. A user can then type and/or select items into the list that they desire to purchase from said store. After creating at least one list, the mobile application may automatically or manually allow the user to sort the list into at least one category such as the name and/or specific location of at least one store in which the items on the list are located. The application also allows a user to (or may automatically) sort the list into at least one subcategory. The subcategory may relate to the types of items on the list.

The mobile application also has at least one location feature which tracks the location of the smart device the application is installed on and also tracks the location of every type/brand of store that has been categorized. Then, the feature automatically detects when the smart device is present at one of said stores. Once the location feature detects that the smart device is present at a location of a store listed in the category, the application alerts a user via a notification feature. The notification feature then brings up any created lists for the category of the store and presents them to the user. This ensures the user is aware of the list(s) when they arrive at the store such that they can purchase each item on the list.

The present invention is also comprised of a method of using the device. First, a device is provided comprised of a mobile application that allows a user to create at least one shopping list that may be sorted into categories and/or subcategories, and then notify the user of the list when they are present at a store which contains the items on the list. First, a user downloads the application onto a smart device. Then, a user creates at least one shopping list. Then, the user may manually sort the list (or the application may automatically sort the list) into categories and subcategories. Next, a user can travel to a location of the store, wherein the mobile application reminds the user of the list when they arrive at the location and wherein a user can view the reminder on the smart device in the form of a notification.

Accordingly, the shopping list reminder mobile application of the present invention is particularly advantageous as it provides an improved shopping list. More specifically, the application eliminates the need to carry a physical shopping list. Further, the application prevents a user from forgetting the existence of a digital shopping list when they arrive at a store. In this manner, the shopping list reminder mobile application overcomes the limitations of existing methods and usages of shopping lists known in the art.

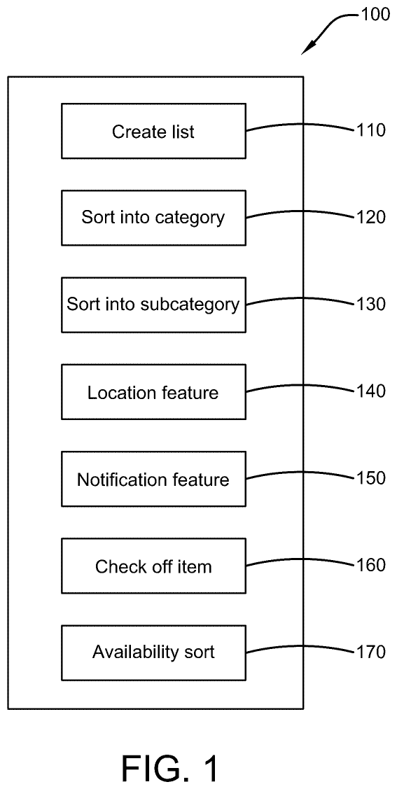

Referring initially to the drawings, FIG. 1 illustrates a graphical view of features of one potential embodiment of a shopping list reminder mobile application of the present invention in accordance with the disclosed architecture. The mobile application 100 allows a user to create at least one shopping list 110. The application 100 then automatically notifies a user 150 of the list when a user enters a store that has the items on said list. In this manner, the user will not forget to purchase said items when they enter said store. The mobile application 100 can preferably be downloaded on any smart device such as, but not limited to, cell phone, computer, tablet, etc.

The first feature of the mobile application 100 allows a user to create at least one list 110. The list is preferably in the form of a numbered shopping list, although the list may be in any format, style, configuration, etc. A user can then type and/or select items into the list that they desire to purchase from said store.

After creating at least one list 110, the mobile application 100 may automatically or manually allow the user to sort the list into at least one category 120. In one embodiment, the category is the name and/or specific location of at least one store in which the items on the list are located. The application 100 also allows a user to (or may automatically) sort the list into at least one subcategory 130. The subcategory 130 may relate to the types of items on the list.

By way of example, a user may first create a list of items to buy at a specific grocery store. The application 100 then sorts the list 120 under a category for that specific grocery store. Then, the application 100 may sort the list under a subcategory 130 within the first category 120, such as, but not limited to, produce, dairy, snacks, etc. This allows a user to create multiple lists for multiple sections of said store. The application 100 then categorizes a plurality of lists 120 by store and may further categorize the lists 130 by the section of the store, category of the item, etc.

The mobile application 100 also has at least one location feature 140. The feature 140 tracks the location of the smart device the application 100 is installed on. The feature 140 also tracks the location of every type/brand of store that has been categorized 120. Then, the feature 140 automatically detects when the smart device is present at one of said stores. It should be appreciated that the feature 140 can be configured/set to a specific brand store of a specific address, or all addresses of a specific type, company, brand, etc. of store.

Once the location feature 140 detects that the smart device 100 is present at a location of a store listed in the category 120, the application alerts a user via a notification feature 150. The notification feature may be in a plurality of different forms in different embodiments, including, but not limited, to a call, a text, an email, an app notification, an alarm, a push notification, etc. The notification feature 150 then brings up any created lists for the category 120 of store and presents them to the user. This ensures the user is aware of the list(s) when they arrive at the store such that they can purchase each item on the list. After each item has been acquired within the store, the application 100 may allow a user to check off/remove each item 160 off the list.

In one embodiment, the application 100 may sort lists into different categories 120 via the availability of items at specific stores. For example, if some items on a list are only available at a first location of a specific brand store and other items on the list are only available at a second location of a specific brand store, the application 100 will create two separate categories 120 of lists, each featuring the items available in each specific brand store. This ensures a user knows what specific stores they must travel to in order to purchase each specific item, depending on whether items are in stock, out of stock, or unavailable at specific stores.

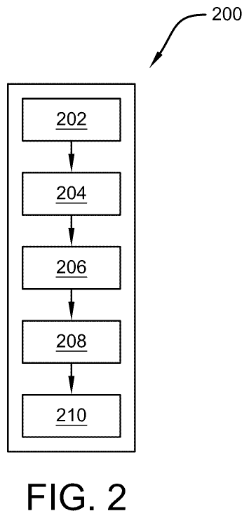

The present invention is also comprised of a method of using 200 the device 100, as seen in FIG. 2. First, a device 100 is provided comprised of a mobile application 100 that allows a user to create at least one shopping list 110 that may be sorted into categories 120 and/or subcategories 130, and then notify the user 150 of the list when they are present at a store which contains the items on the list [Step 202]. First, a user downloads the application 100 onto a smart device [Step 204]. Then, a user creates at least one shopping list 110 [Step 206]. Then, the user may manually sort the list (or the application 100 may automatically sort the list) into categories 120 and subcategories 130 [Step 208]. Next, a user can travel to a location of the store, wherein the mobile application 100 reminds the user of the list when they arrive at the location and wherein a user can view the reminder on the smart device in the form of a notification 150 [Step 210].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “shopping list reminder mobile application” and “application” are interchangeable and refer to the shopping list reminder mobile application 100 of the present invention.

Notwithstanding the foregoing, the shopping list reminder mobile application 100 of the present invention and its various components can be of any suitable size and configuration as is known in the art without affecting the overall concept of the invention, provided that they accomplish the above-stated objectives. One of ordinary skill in the art will appreciate that the size, configuration, and material of the shopping list reminder mobile application 100 as shown in the FIGS. are for illustrative purposes only, and that many other sizes and shapes of the shopping list reminder mobile application 100 are well within the scope of the present disclosure. Although the dimensions of the shopping list reminder mobile application 100 are important design parameters for user convenience, the shopping list reminder mobile application 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A shopping list reminder mobile application comprising:
a mobile application that allows a user to create a list via a first feature;
a second feature that allows the list to be sorted into a category;
a third feature that allows the list to be sorted into a subcategory within the category;
a fourth feature that monitors a location of a smart device the mobile application is installed on and;
a fifth feature comprised of a notification feature.

2. The shopping list reminder mobile application of claim 1, wherein the list is comprised of a shopping list.

3. The shopping list reminder mobile application of claim 1, wherein the second feature manually sorts the list into a category.

4. The shopping list reminder mobile application of claim 3, wherein the category is comprised of a store.

5. The shopping list reminder mobile application of claim 4, wherein the notification feature generates a notification when the fourth feature detects a user has arrived at the specific store that carries an item on the list.

6. The shopping list reminder mobile application of claim 5, wherein the notification is comprised of a call, a text, an email, an app notification, an alarm, or a push notification.

7. The shopping list reminder mobile application of claim 1, wherein the third feature manually sorts the list into a subcategory.

8. A shopping list reminder mobile application comprising:
a mobile application that allows a user to create a list via a first feature;
a second feature that automatically sorts the list into a first category;
a third feature that automatically sorts the list into a subcategory within the category;
a fourth feature that monitors a location of a smart device the mobile application is installed on and;
a fifth feature comprised of a notification feature.

9. The shopping list reminder mobile application of claim 8, wherein the list is comprised of a numbered shopping list.

10. The shopping list reminder mobile application of claim 8, comprised of a sixth feature that allows a user to remove an item from the list.

11. The shopping list reminder mobile application of claim 10, wherein the item is removed by crossing out the item from the list.

12. The shopping list reminder mobile application of claim 8, wherein the first category is comprised of a store.

13. The shopping list reminder mobile application of claim 8, wherein the notification feature generates a notification when the fourth feature detects a user has arrived at the specific store that carries an item on the list.

14. The shopping list reminder mobile application of claim 13, wherein the notification is comprised of a call, a text, an email, an app notification, an alarm, or a push notification.

15. The shopping list reminder mobile application of claim 8, wherein the application is comprised of a seventh feature that creates a second category.

16. The shopping list reminder mobile application of claim 15, wherein the second category is created when an item on the list is not available at a first location of a store.

17. The shopping list reminder mobile application of claim 16, wherein the second category is a second location of the store.

18. A method of using a shopping list reminder mobile application, the method comprising:
providing a shopping list reminder mobile application that allows a user to create a list that may be sorted into a category and a subcategory, and that notifies the user of the list when they are present at a store which contains an item of the list;
downloading the mobile application to a smart device;
creating a list; and
traveling to the store.

19. The method of using a shopping list reminder mobile application of claim 18, wherein the mobile application notifies a user and presents the list to a user when the user travels to the store.

20. The method of using a shopping list reminder mobile application of claim 18, wherein the list is comprised of a shopping list.
